(19) United States
(12) Patent Application Publication
(10) Pub. No.: US 2026/0059306 A1
(43) Pub. Date: Feb. 26, 2026

(54) AUTHENTICATION AND AUTHORIZATION FOR NETWORK-ASSISTED AERIAL SERVICES

(71) Applicant: QUALCOMM Incorporated, San Diego, CA (US)

(72) Inventors: Sunghoon KIM, San Diego, CA (US); Stefano FACCIN, San Ysidro, CA (US); Drew Foster VAN DUREN, Templeton, CA (US); Kefeng ZHANG, Beijing (CN)

(21) Appl. No.: 19/101,857

(22) PCT Filed: Sep. 22, 2022
(86) PCT No.: PCT/CN2022/120516

§ 371 Date: Feb. 6, 2025

(51) Int. Cl. H04W 12/06; H04W 12/08; H04W 84/06

(52) U.S. Cl. CPC H04W 12/06; H04W 12/08; H04W 84/06

(57) ABSTRACT

Certain aspects of the present disclosure provide techniques for method of wireless communication at a first network entity, generally including receiving signaling indicating that a user equipment (UE) is deployed on an unmanned aerial vehicle (UAV), performing a first procedure with a second network entity to authenticate and authorize communications between the UE and the first network entity, and communicating with the UE, using security material obtained via the first procedure, to provide network-based aviation service.

### BACKGROUND

### Field of the Disclosure

Aspects of the present disclosure relate to wireless communications, and more particularly, to techniques for providing support for network-based aviation services for unmanned aerial vehicles (UAVs).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a first network entity. The method includes receiving signaling indicating that a user equipment (UE) is deployed on an unmanned aerial vehicle (UAV); performing a first procedure with a second network entity to authenticate and authorize communications between the UE and the first network entity; and communicating with the UE, using security material obtained via the first procedure, to provide network-based aviation service.

Another aspect provides a method of wireless communication at a second network entity. The method includes performing a first procedure with a first network entity to authenticate and authorize communications between a UE deployed on an UAV and the first network entity; and providing security material, as part of the first procedure, to at least the first network entity for use in securing communications when the first network entity provides network-based aviation service to the UE.

Another aspect provides a method of wireless communication at a UE. The method includes transmitting signaling, to a first network entity, indicating that the UE is deployed on an UAV; receiving security material if communication between the UAV and first network entity is authorized; and communicating with the first network entity, using the security material, to obtain network-based aviation service.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of an unmanned aerial vehicle (UAV).

FIG. 6 depicts an example deployment of UAVs, in accordance with aspects of the present disclosure.

FIG. 7 depicts an example of network assisted support of UAVs, in accordance with aspects of the present disclosure.

FIG. 8 depicts an example architecture for network assisted support of UAVs, in accordance with aspects of the present disclosure.

FIG. 9 depicts an example call flow diagram for authorizing and authenticating network assisted support of UAVs, in accordance with aspects of the present disclosure.

FIG. 10 depicts an example call flow diagram illustrating network assisted support of UAVs, in accordance with aspects of the present disclosure.

FIG. 11 depicts an example call flow diagram illustrating network assisted support of UAVs, in accordance with aspects of the present disclosure.

FIG. 12 depicts a method for wireless communications.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for providing support for network-based aviation services for unmanned aerial vehicles (UAVs) and Urban Air Mobility (UAM) use cases.

An unmanned aerial vehicle (UAV), also referred to as a drone, generally refers to an aircraft without any humans on board. UAVs may be deployed as part of an unmanned aircraft system (UAS) that typically includes a ground-based UAV controller (UAVC). At least some portions of the flight of a UAV may operate under remote control by a human operator, with autopilot assistance, or as a fully autonomous aircraft.

UAVs may fly at a relatively low level when compared to conventional commercial aircraft (e.g., 5000 feet or lower). UAVs may also fly in very different sets of scenarios than commercial aircraft, such as in crowded spaces (e.g., with 10 or more UAVs in a 1 square km area). As a result, to fully enable UAVs, mechanisms should be in place to detect and avoid collisions.

For example, sense and Avoid (SAA) or Detect and Avoid (DAA) systems generally refer to technologies that are designed to allow UAVs to integrate safely into civilian airspace. Such systems help UAVs avoid collisions with other aircraft, buildings, power lines, birds and other obstacles. These systems may observe the environment surrounding the UAV, decide whether a collision is imminent, and generate a new flight path in order to avoid collision (a plan to avoid such collision is referred to herein as deconfliction).

As will be described in greater detail below, such UAV sense and avoid systems may combine data from a number of sensors, using sensor fusion algorithms, image recognition and artificial intelligence (AI) in an effort to provide the best outcome. Data is typically fed back to the UAV on-board computer and/or the flight controller (UAVC), which can then decide on the best evasive maneuver or flight path correction to avoid collision.

A reliable onboard DAA system may be important for obtaining a waiver for flight operations in many jurisdictions that typically would otherwise require human observers (and/or ground-based observation systems) along the entire flight path. DAA systems are, thus, important for unlocking commercially viable beyond visual line of sight (BVLOS) UAV operations that provide services such as inspection and cargo delivery over extremely long distances.

Conventional DAA solutions are typically sensor-based or communication-based. Sensor-based solutions typically employ a combination of active sensors (e.g., SONAR, LIDAR, and RADAR) and passive sensors (e.g., electro-optical sensors, such as cameras, and acoustic sensors). For communication-based DAA solutions, UAVs could use systems originally designed for manned aviation, such as traffic collision and avoidance systems (TCAS) or automatic dependent surveillance-broadcast (ADS-B) systems that periodically broadcast and receive identity, position and other information. Unfortunately, current DAA solutions may be less than ideal and may only accommodate a relatively narrow set of use cases.

Aspects of the present disclosure, however, provide network-assisted aviation services that may leverage existing infrastructure to provide a flexible DAA solution. Such a network-assisted DAA solution may help minimize or avoid reliance on remote pilot stations (RPS), UAVCs, ground control stations (GCS), and human pilots. The techniques presented herein may assumes some degree of automation in the UAV, without relying solely on the UAV awareness of surrounding traffic (though onboard sensors and information collection may still be leveraged. The solutions provided herein may still leverage UAV to UAV (U2U) communications to collect information, such as Airborne Collision Avoidance Systems (ACAS) related information. The solutions may also leverage the ground network ability to have higher spatial awareness of traffic (e.g., by sharing data gathered regarding different UAVs).

Aspects of the present disclosure may also provide techniques for authorizing and authenticating network-based UAV services. For example, a network entity, such as a localized DAA service (LDS), may perform a first procedure with a second network entity, such as an unmanned aircraft system (UAS) service suppliers (USS) node or a UAS Traffic Management (UTM) node, to authenticate and authorize communications between a UE deployed on a UAV and the first network entity.

The first network entity may then securely communicate with the UE using security material obtained via the first procedure. Thus, aspects of the present disclosure may help secure communications related to network-assisted aerial services, potentially protecting against various types of attacks, such as integrity, authentication (anti-spoofing) and replay attacks.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

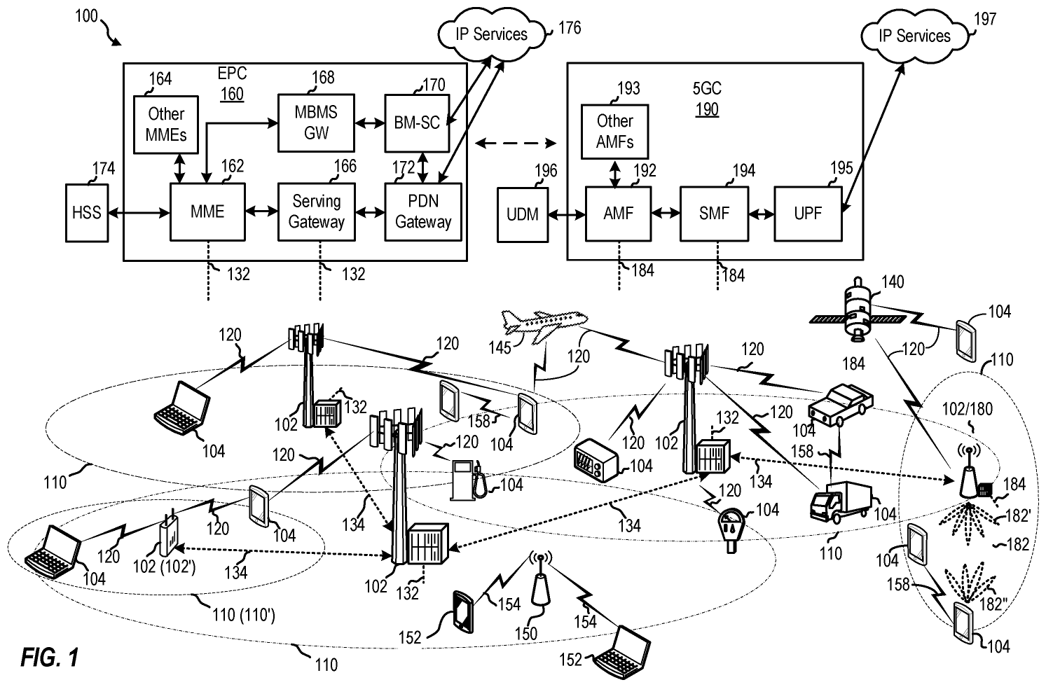

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

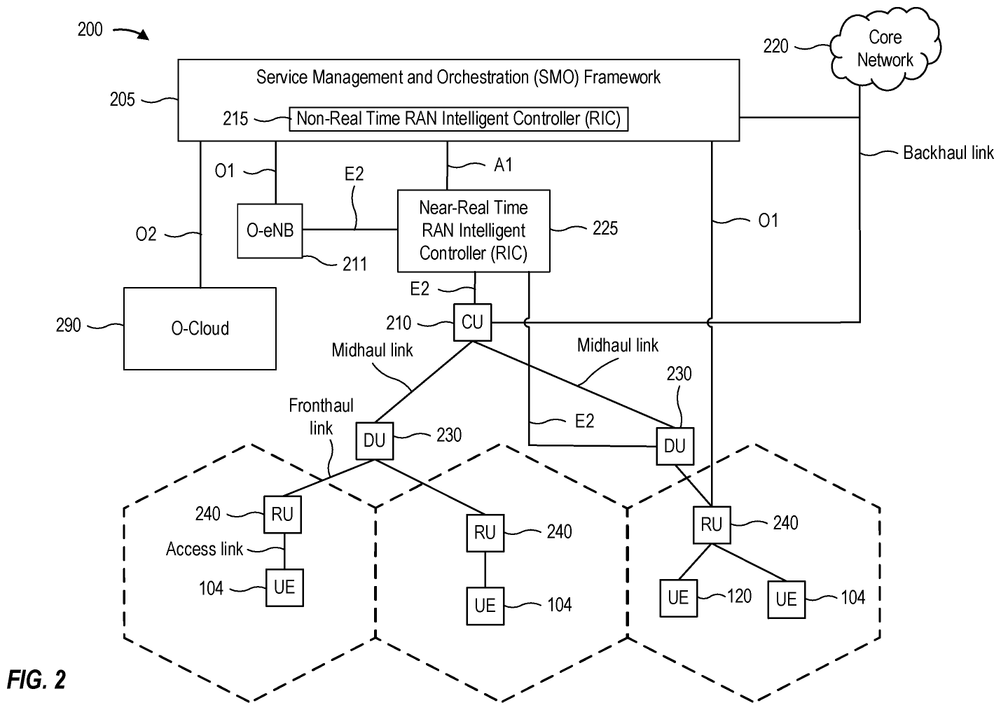

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an Ol interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

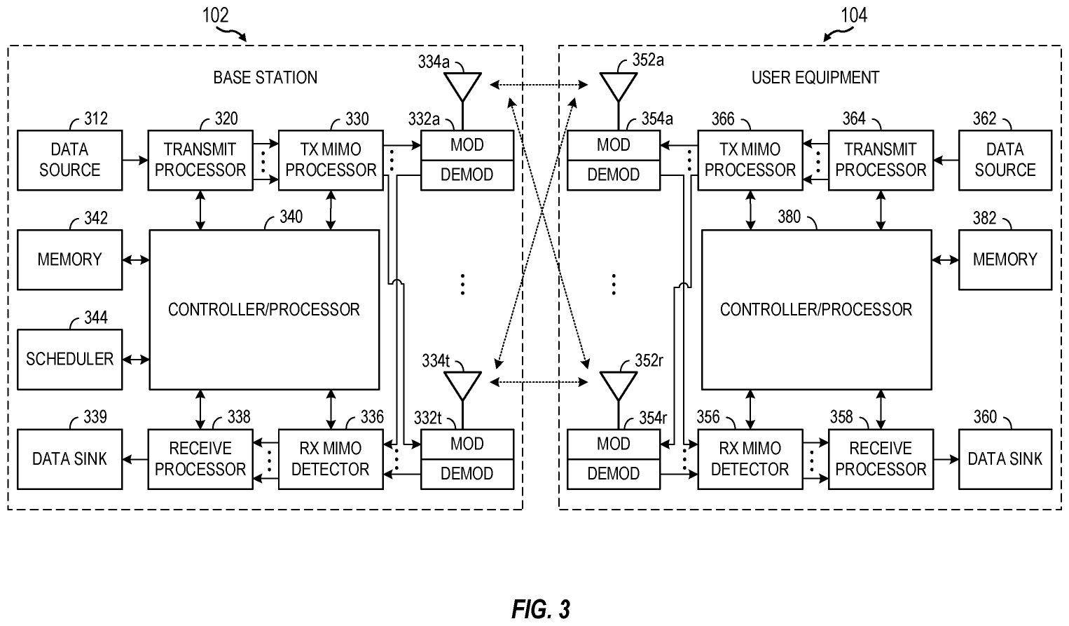

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

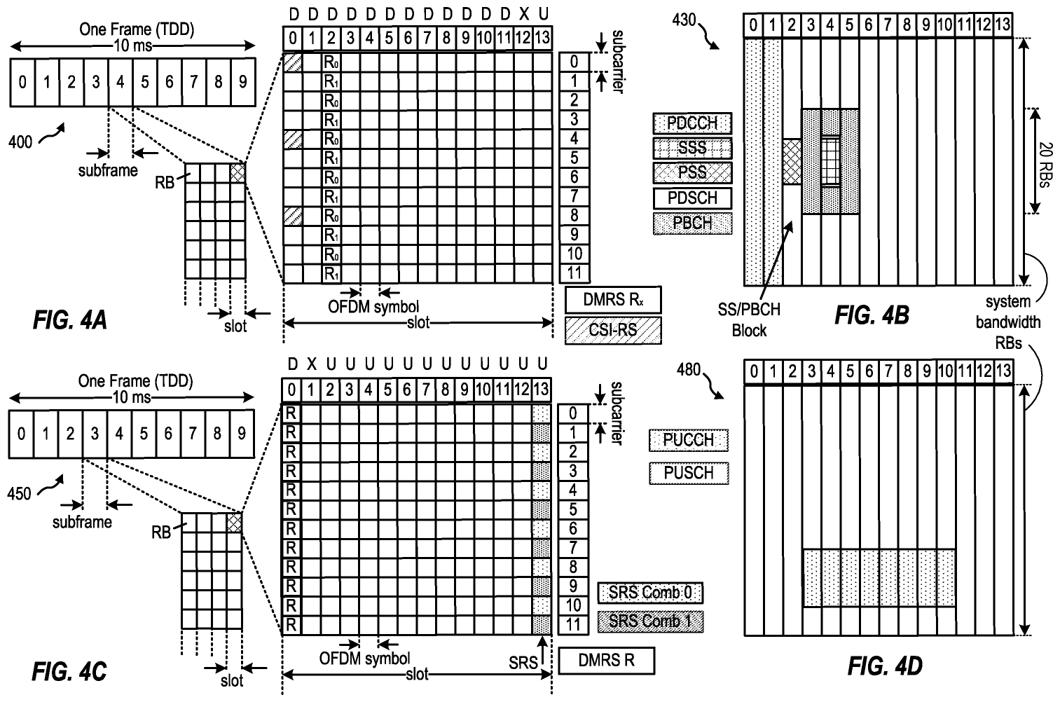

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### An Overview of UAVS

As noted above, an unmanned aerial vehicle (UAV) generally refers to an aircraft (without any humans on board) that may be deployed as part of an unmanned aircraft system (UAS). UAVs may be deployed in different scenarios with different objectives for uplink transmission power control.

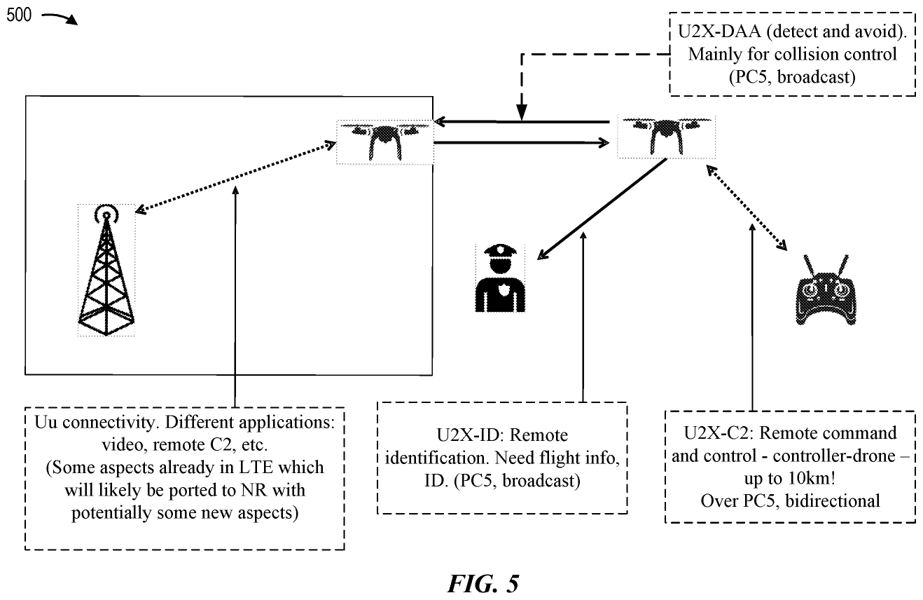

For example, as illustrated in FIG. 5, on the cellular (Uu) link, a UAV may support different applications, such as video and remote command and control (C2) applications. A UAV to everything (U2X) application may need identification, for example, with flight information (e.g., via a sidelink/PC5 broadcast). A U2X detect and avoid (DAA) application identification may be used mainly for collision control (e.g., via PC5 broadcast). A U2X-C2 remote command and control (a controller-drone) could reach up to 10 km, with communications over PC5 and possibly bidirectional.

### Overview of UAV and Localized DAA Service (LDS)

Aspects of the present disclosure provide mechanisms that enable network-based aviation services for unmanned aerial vehicles (UAVs).

As noted above, UAVs may be deployed as part of an unmanned aircraft system (UAS) that typically includes a ground-based UAV controller (UAVC). Sense and Avoid (SAA) or Detect and Avoid (DAA) systems are designed to allow UAVs to integrate safely into civilian airspace, by helping UAVs avoid collisions with other aircraft, buildings, power lines, birds and other obstacles.

Aspects of the present disclosure provide network-assisted aviation services that may leverage existing infrastructure to provide a flexible DAA solution. The network-assisted solutions provided herein may still leverage UAV to UAV (U2U) communications to collect information and may also leverage the ground network ability to have higher spatial awareness of traffic (e.g., by sharing data gathered regarding different UAVs). The network-assisted solutions proposed herein may utilize an AI machine learning (AI-ML)-based server, referred to herein as a localized DAA server.

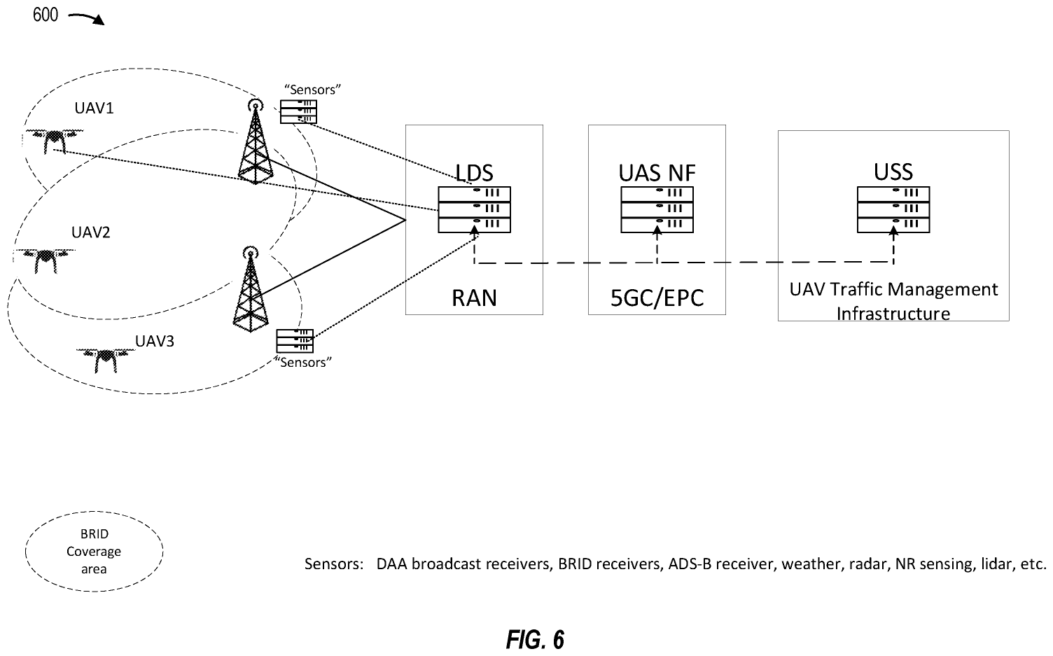

As illustrated in FIG. 6, the LDS may be placed in a radio access network (RAN) and serve as a localized USS and/or UAS Traffic Management (UTM) UTM node tailored specifically for DAA. The LDS may perform predictive confliction management and mitigation and, in some cases, may provide a ‘subscription-based’ traffic separation service.

LDS nodes may enhance spatial awareness of UAVs within a UAS, based on information collected on UAVs (and other aerial vehicles). The network-assisted service proposed herein may rely on gNBs and other sources of information feeding data to the LDS. In some cases, sensors may be deployed at gNBs (e.g., DAA broadcast receivers, BRID receivers, ADS-B receiver, weather, radar, NR sensing, LIDAR, etc.). LDS nodes may implement traffic separation algorithms and collision notification features across 1 or more cells; A UAV may be visible to multiple LDSs.

As illustrated, an LDS could interact and leverage with various 5G core network functions, such as a network function (NF) to leverage a network exposure function (NEF) for interaction with global UTM and USSs. In some cases, an LDS may provide (via NEF exposure), an aerial congestion information application programming interface (API) and UAV information to the USS, which may help to support the USS in flight authorization.

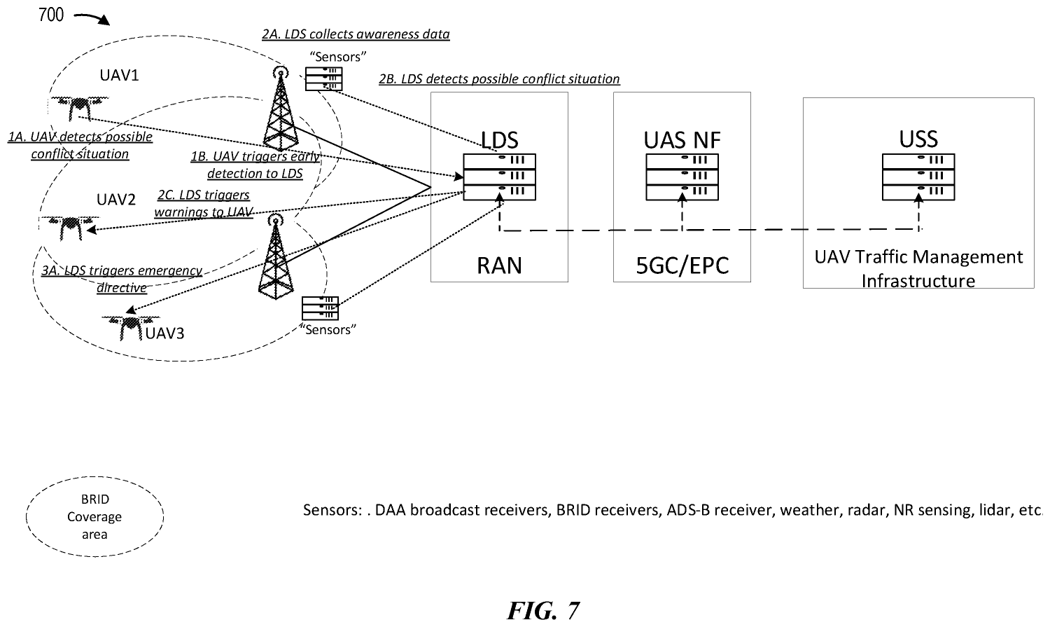

As illustrated in FIG. 7, in some cases, the network-assisted aviation services proposed herein may rely on explicit communication between UAV and LDS. For example, (as shown at 1A and 1B) a first UAV, UAV1 registered in a 5G System, may send information to the LDS according to various options. For example, the UAV may send information about the UAV itself and/or other UAVs that the UAV has detected (such as a possible collision). This information may help trigger early detection at the LDS. The UAV may also send requests for deconfliction when the UAV detects a possible conflict.

As shown at 2A, the LDS may collect awareness data (e.g., from sensors deployed at a gNB and/or data from UAVs relayed through a gNB). (As shown at 2B), the LDS may detect a possible conflict situation, based on the collected information and may take appropriate action. For example, (as shown at 2C), the LDS may trigger a warning to another UAV (e.g., UAV2). As shown at 3A, if a collision is imminent, the LDS may trigger an emergency directive to another UAV (e.g., UAV3).

In some cases, the LDS may interact with the USS, via a NEF. For example, the LDS may provide aerial congestion/conflict information to an external application function (AF) acting as USS to support flight planning. In some cases, the LDS may retrieve UAV information (e.g., public information, such as UAV category, mission type, etc.) from the USS via NEF as soon as the LDS detects a UAV and finds that information on this UAV is not available locally.

In some cases, sensing data collection and analysis can leverage sensing network capability and may performed within the LDS or may leverage capability of a network data analytics function (NWDAF). As will be described in greater detail below, aspects of the present disclosure provide various mechanisms for communicating between the UAV and LDS, between the LDS and USS (via the NEF). Such mechanisms may include discovery of functionality, including the network discovering a UAV is capable of supporting network-assisted aerial services (e.g., via a LDS) and/or a UAV discovering the network supports/provides network-assisted aerial services (e.g., via a LDS).

In some cases, a UAV may first need to discover whether a network provides network-based aviation service support (e.g., existence of an LDS). In addition, or as an alternative, the network may need to learn whether the UE is capable of participating in network-based aviation service support (e.g., can communicate with an LDS).

To accomplish this discovery, the UE (deployed on a UAV) may transmit signaling indicating the UE is associated with an unmanned aerial vehicle (UAV). This signaling may indicate that the UE is capable of supporting LDS (or network assisted DAA, NA-DAA). The indication may be provided via non access stratum (NAS) signalling, such as 5G mobility management (5GMM) capabilities signaling. In some cases, the UE/UAV may receive signaling indicating that a network supports a network-based aviation service. For example, the network may provide an indication of LDS.

In some cases, when registering in a public land mobile network (PLMN) registration procedure, the PLMN may indicate that LDS service is supported in a UE registration procedure. In some cases, LDS availability may be indicated per PLMN. In other cases, LDS availability may be indicated per Registration Area (RA). In some cases, an access and mobility management function (AMF) may also generate an RA in a manner designed to ensure that LDS service is uniformly available in RA.

LDS service may not be available in all locations within a wireless network. Therefore, in some cases, a cell system information block (SIB) may include an indication of “LDS available” when the LDS service is available. A similar such indication may be sent via RRC establishment signalling. In either case, a gNB may be configured to know whether LDS is available.

As described herein, the network-assisted DAA (NADAA) solution proposed herein may leverage existing infrastructure and the support of UAVs via wireless networks. Aspects of the present disclosure also provide a mechanism to enable the core network to configure the RAN with information about the UAV and policies related to the NADAA service supported by a Localized DAA Service (LDS).

In some cases, the LDS may be provided by RAN and communication between a UAV and the LDS may occur over a form of (modified) RRC signalling. I some cases, the LDS may be provided by an edge server and communications carried out over user plane (UP) signalling between the UAV and the edge.

In some cases, an AMF may retrieve information from a unified data manager (UDM), may receive an explicit indication from the UAV, and policies from a Policy Control Function (PCF), related to the LDS service, and configure the RAN accordingly.

In some cases, if the LDS service is authorized, for example, via a (UAS) service suppliers (USS) UAV authorization/authentication (UUAA) procedure and UUAA session management (UUAA-SM) is used (at PDU session establishment), then the SMF may provide the configuration information to the RAN.

As noted above, AMF to RAN communications may be used to support the NADAA proposed herein. In some cases, upon UE registration, the UE may indicate a subscription. If the UE subscription is for an aerial UE (a UAV UE deployed on a UE) and if the AMF successfully authenticates the UAV UE, the AMF may authenticate and authorizes the UAV. In this case, the AMF may indicate to the RAN whether LDS is authorized for this UE. In some cases, the AMF may also require successful UUAA authentication/authorization. In some cases, the UAV may also be expected to indicate (e.g., in 5GMM capabilities) that it supports LDS service.

For scenarios in which UUAA-SM is performed, the SMF may indicate to the RAN (e.g., by adding a new indication in N2 SM message) whether LDS is authorized for the UE after UUAA-SM completion.

As noted above, in some cases, new network exposure function (NEF) services may be defined to support UAVs with network-assisted aerial services. For example, new NEF services may be introduced to enable an LDS to register itself with the UAS NF (NEF) and with the USS, in order to retrieve information about a UAV that the LDS is serving, and to receive configuration information from the USS.

As noted above, a UE that is capable of LDS may indicate it supports LDS at the application layer, for example, during a UUAA procedure to the USS. After the UAV indicates its LDS capability to the USS, upon a successful UUAA procedure, the USS may provide the UAS NF an indication that NADAA is authorized.

In some cases, the LDS may also interact with the USS to report detected UAS conflicts (e.g., potential UAV collisions) and corrective action to USS. In some cases, an interface may be defined between the LDS to NEF/UAS NF to trigger signaling to the USS. In such cases, it may be assumed that the LDS is not aware of the serving USS. In other words, no information about the serving USS may be provided to the LDS and the LDS may not discover the serving USS. Thus, even though the USS is not aware of the LDS serving a UAV, the LDS can communicate with the UAS NF, which communicates with USS.

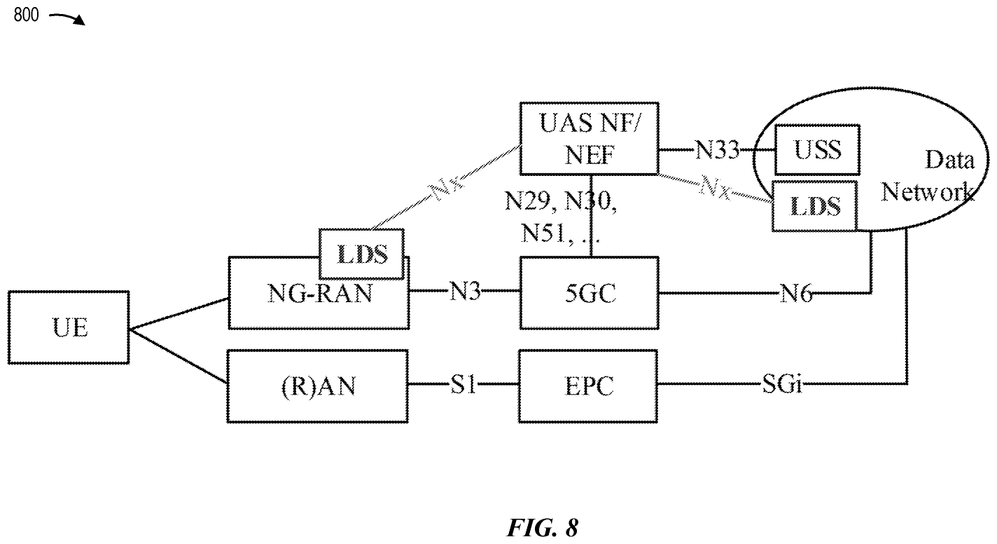

FIG. 8 illustrates an example architecture 800 of a network capable of providing network assisted aerial services to a UE (e.g., a UE on a UAV). As illustrated, the LDS may be located in a RAN (e.g., NG-RAN) or in a data network (e.g., with the USS). As noted above, the LDS may interact with the USS, via a UAS NF or NEF. In some cases, the LDS may retrieve UAV information (e.g., public information, such as UAV category, mission type, etc.) from the USS via NEF as soon as the LDS detects a UAV.

### Example Authentication and Authorization for Network-Assisted Aerial Services

Aspects of the present disclosure may also provide techniques for authorizing and authenticating network-based UAV services. For example, a network entity, such as a localized DAA service (LDS), may perform a first procedure with a second network entity, such as an unmanned aircraft system (UAS) service suppliers (USS) node or a UAS Traffic Management (UTM) node, to authenticate and authorize communications between a UE deployed on a UAV and the first network entity.

The techniques proposed herein may be used to secure information exchanged between a UAV and LDS. In some cases, such communications may be secured using public key solutions for BRID, which can be based on a U2X security model (e.g., public key infrastructure and certificates based on IEEE 1609.2 standards), where the LDS may have access to mechanisms to verify the signed information (e.g., via UAS-NF).

The techniques may help ensure information from the LDS to UAV can be trusted by the UAV. For example, if emergency directives are sent from the LDS to the UAV, aspects of the present disclosure may help ensure that the UAV is able to authenticate the LDS identity and permissions. For communications at the IP layer between the UAV and LDS, when the UAV and LDS set up a session, the mechanisms proposed herein may help establish (or provide reference to) keying material to help ensure the UAV can verify and trust incoming commands.

Various solutions are proposed herein to secure information exchanged between a UAV and LDS. The solutions may vary in how various entities interact and which entities trigger certain procedures. The various techniques described herein to authenticate and authorize communications between a UE deployed on a UAV and an LDS may also be applied to other types of devices. For example, the techniques described herein (or similar techniques) may also be applied to authenticate and authorize communications between various types of manned vehicles and LDS or other types of servers.

For example, according to a first solution, the LDS performs a first Authentication/Authorization procedure with the USS (via UAS-NF) by using APIs defined for UUAA. The LDS then performs a second AA procedure with the UAV.

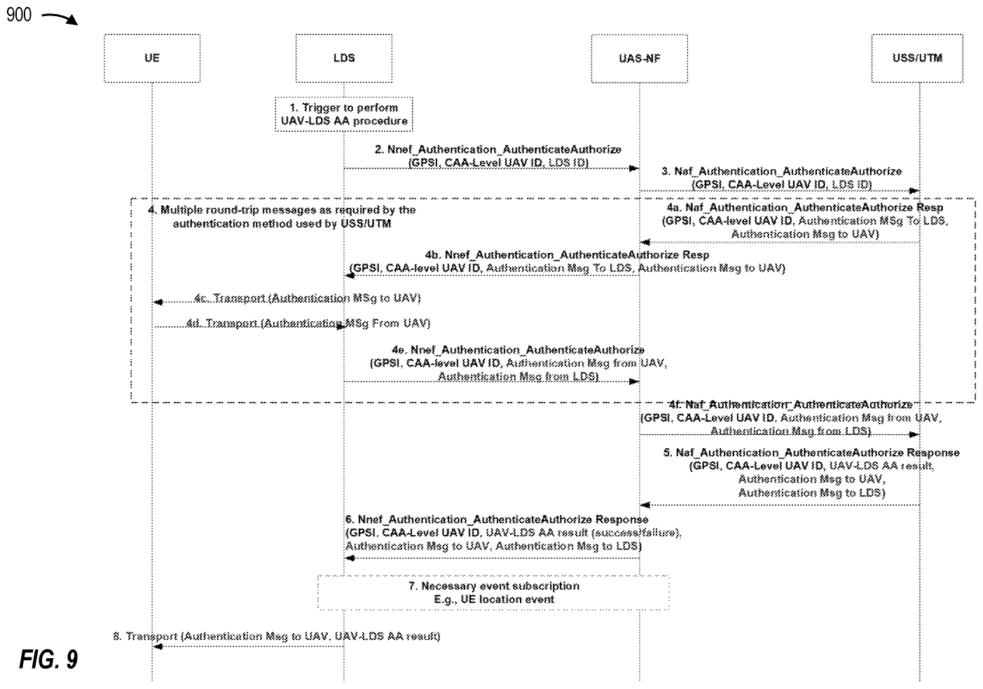

This first solution may be understood with reference to the call flow diagram 900 of FIG. 9. The illustrated example may assume that the UE has already performed a UUAA procedure with the USS, that the UE has performed LDS discovery, and that the UE has initiated application layer signaling.

As illustrated, at a first step (Step 1), the LDS may decide to trigger UAV-LDS AA procedure. For example, the decision to trigger may be based upon the UAV contacting the LDS. At a second step (Step 2), the LDS invokes Nnef_Auth API, including the LDS ID as an indication that the procedure is for UAV-LDS AA. In this step, the GPSI (the UAV's GPSI) may be provided to identify the UE in 3GPP system. At a third step (Step 3), the USS checks if the UAV is allowed to access the LDS.

At a fourth step (Step 4), the USS performs AA procedure and generates an authentication message (Auth Msg) to UAV and LDS respectively (Step 4a) and forwards the messages to the LDS via the UAS-NF (Step 4b). The UE (UAV) and LDS perform an authentication procedure (at Steps 4c and 4d). The LDS forwards the Auth Msg to the UAV transparently (without modification).

As illustrated (at Step 5 to 8), the UAV-LDS Authentication and Authorization (AA) procedure result, along with any relevant security related material (e.g., access token, security materials) may be provided to the UAV and LDS.

According to a second solution, the LDS performs a first Authentication/Authorization procedure and, as a part of this procedure, the USS triggers UUAA procedure with UAV. After completion of both AA procedure (LDS AA and UUAA), the USS indicates the LDS to communicate with UAV.

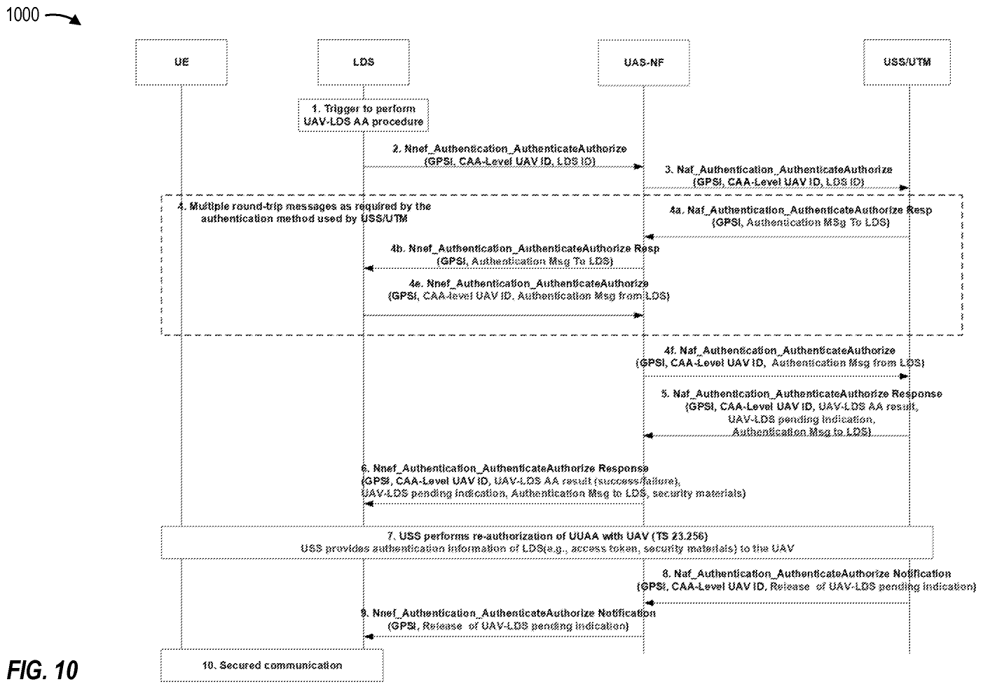

This second solution may be understood with reference to the call flow diagram 1000 of FIG. 10. The illustrated example may assume that the UE has already performed a UUAA procedure with the USS, that the UE has performed LDS discovery, and that the UE has initiated application layer signaling. It also assumes the LDS has discovered the UE (e.g., based on BRID or other sensing).

As illustrated, at a first step (Step 1), the LDS may decide to trigger UAV-LDS AA procedure (e.g., upon the UAV contacting the LDS). At a second step (Step 2), the LDS invokes Nnef_Auth API, including the LDS ID as an indication that the procedure is for UAV-LDS AA.

In this step, the GPSI (the UAV's GPSI) may be provided to identify the UE in 3GPP system. At a third step (Step 3), the USS checks if the UAV is allowed to access the LDS. The LDS may include the UAV ID (GPSI, CAA-level UAV ID) to identify the target UAV. At a third step (Step 3), the USS checks if the UAV is allowed to access the LDS.

At a fourth step (Step 4), the USS performs AA procedure with LDS for the UAV-LDS connection. At a fifth step (Step 5), if the LDS-AA procedure completes successfully, the USS decides to trigger re-UUAA with UAV (as Step 7). In order to suspend the communication between UAV and LDS (at step 6), the USS sends ‘UAV-LDS pending indication’ to the LDS. This may cause the LDS to refrain from communication with UAV before the pending indicate is released (at step 9).

At step 7, the USS performs a UUAA procedure with UAV, and provides the authentication information of the LDS (e.g., access token, security materials) to the UAV during this procedure. After a successful UUAA with the UAV, at step 8-9, the USS sends a ‘release of UAV-LDS pending indication’ so that the LDS can initiate communication with UAV.

According to a third solution, the LDS performs LDS-UAV authorization procedure with USS. In this solution, the USS authorizes the connection between the UAV and LDS. The USS then provides the certificate/security keys to LDS and UAV, respectively, so the UAV can trust the traffic from the LDS.

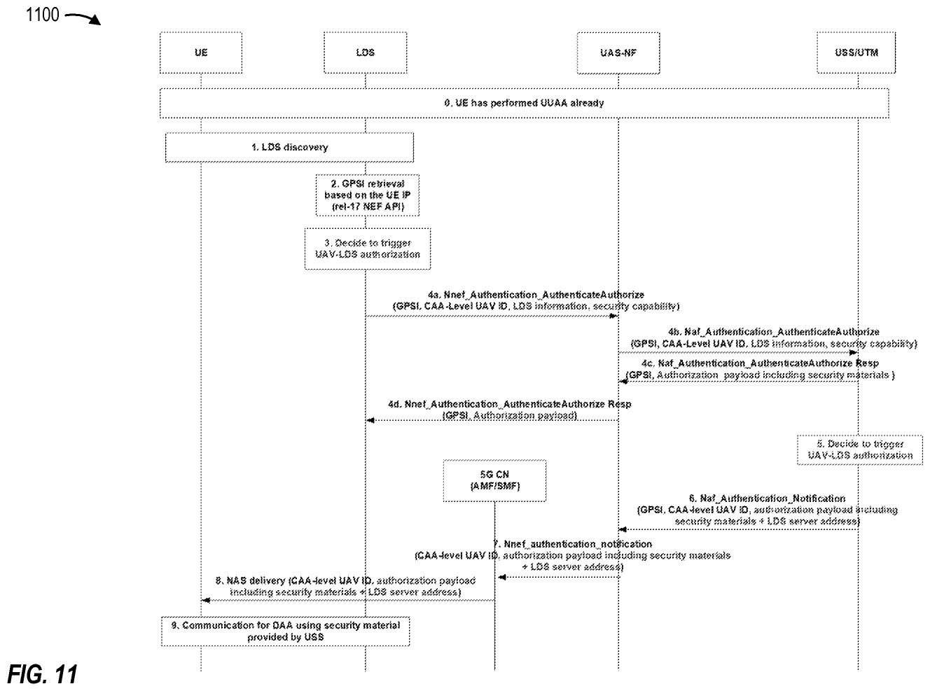

This third solution may be understood with reference to the call flow diagram 1100 of FIG. 11. The illustrated example may assume that the UE has already performed a UUAA procedure with the USS.

As illustrated, at a first step (Step 1), the UE performs LDS discovery. At a second step (Step 2), the LDS may retrieve the GPSI based on the UE IP (e.g., using a NEF API).

At a third step (Step 3), the LDS may decide to trigger UAV-LDS AA procedure with the UE. At steps 4a-4d, the LDS negotiates the security capability. The LDS information may be included (e.g., LDS ID, URL, etc.) to indicate the request is for UAS-LDS authorization.

Upon success of the UAV-LDS authorization procedure, at Step 5, the USS triggers UAV-LDS authorization with the UE. At step 6, the USS provides authorization payload including security materials (key or certificate) and LDS server address (LDS ID or URL), which is forwarded to the UAV at steps 7 and 8.

The UAV and LDS then communicate for DAA, at Step 9, by using the security materials (e.g., certificate, security keys). If any of the material does not match, the traffic will be discarded at receiver side. In some cases, the USS may trigger the UAV-LDS AA procedure before negotiating the security capability with the LDS once the USS decides to authorize the communication btw UAV/LDS (e.g., step 5 may be performed after step 4b).

### Example Operations of Network Entities

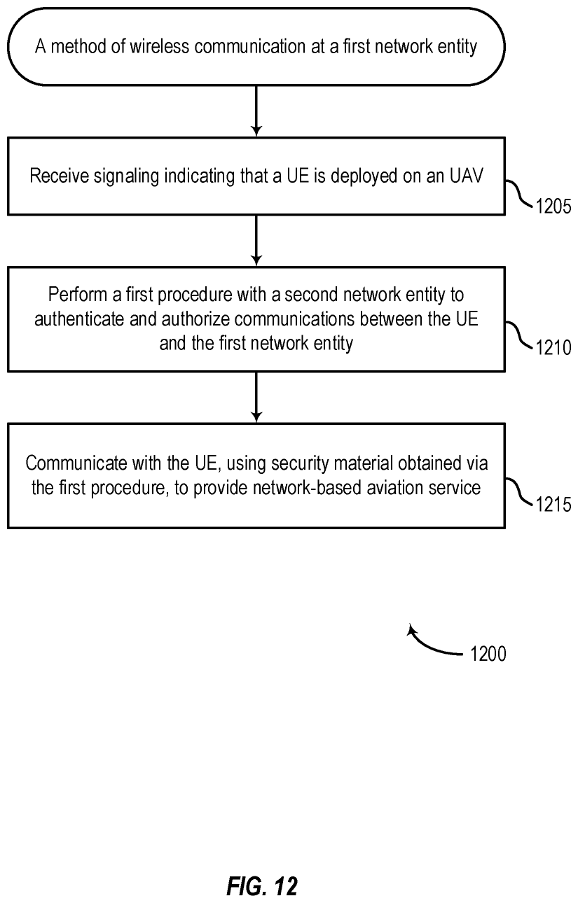

FIG. 12 shows an example of a method 1200 of wireless communication at a first network entity, such as a BS 102 of FIGS. 1 and 3, or a disaggregated base station as discussed with respect to FIG. 2.

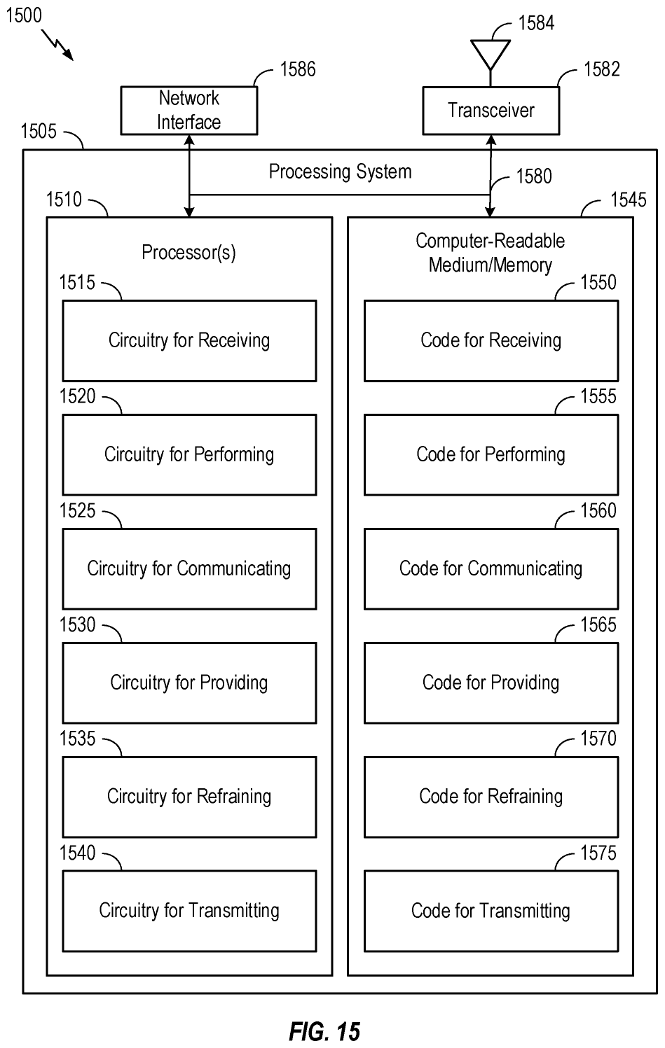

Method 1200 begins at step 1205 with receiving signaling indicating that a UE is deployed on an UAV. In some cases, the operations of this step refer to, or may be performed by, circuitry for receiving and/or code for receiving as described with reference to FIG. 15.

Method 1200 then proceeds to step 1210 with performing a first procedure with a second network entity to authenticate and authorize communications between the UE and the first network entity. In some cases, the operations of this step refer to, or may be performed by, circuitry for performing and/or code for performing as described with reference to FIG. 15.

Method 1200 then proceeds to step 1215 with communicating with the UE, using security material obtained via the first procedure, to provide network-based aviation service. In some cases, the operations of this step refer to, or may be performed by, circuitry for communicating and/or code for communicating as described with reference to FIG. 15.

In some aspects, the second network entity comprises: an USS node; or a UTM node.

In some aspects, the security material comprises at least one of security keys, certificates, or access tokens.

In some aspects, the first procedure comprises an authentication and authorization procedure performed using an API to communicate with the second network entity via a NF; and the first network entity provides the second network entity a server ID to indicate the first procedure is to authenticate and authorize communications between the UE and the first network entity.

In some aspects, the first network entity obtains, as part of the first procedure, a first authentication message for the first network entity and a second authentication message for the UE.

In some aspects, the method 1200 further includes performing a second procedure with the UE to provide the UE with the second authentication message. In some cases, the operations of this step refer to, or may be performed by, circuitry for performing and/or code for performing as described with reference to FIG. 15.

In some aspects, the method 1200 further includes providing the UE with results of the second procedure and the security material. In some cases, the operations of this step refer to, or may be performed by, circuitry for providing and/or code for providing as described with reference to FIG. 15.

In some aspects, the first network entity provides the second network entity an ID of the UAV to trigger the second network entity to perform a second procedure to authenticate and authorize the UE.

In some aspects, the method 1200 further includes receiving, from the second network entity, a first indication indicating a pending status during which the first network entity should refrain from communicating with the UE. In some cases, the operations of this step refer to, or may be performed by, circuitry for receiving and/or code for receiving as described with reference to FIG. 15.

In some aspects, the method 1200 further includes refraining from communicating with the UE until after receiving, from the second network entity, a second indication indicating a release of the pending status. In some cases, the operations of this step refer to, or may be performed by, circuitry for refraining and/or code for refraining as described with reference to FIG. 15.

In some aspects, the first network entity provides the second network entity an ID of the UAV to request the second network entity to authorize communication between the first network entity and the UE.

In some aspects, the second network entity provides the security material to the first network entity and UE.

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative steps are possible consistent with this disclosure.

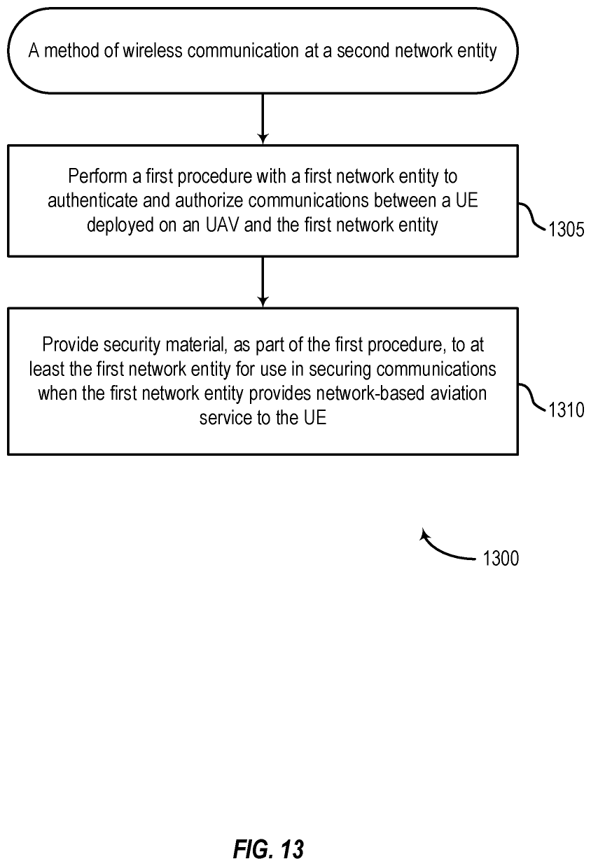

FIG. 13 shows an example of a method 1300 of wireless communication at a second network entity, such as a BS 102 of FIGS. 1 and 3, or a disaggregated base station as discussed with respect to FIG. 2.

Method 1300 begins at step 1305 with performing a first procedure with a first network entity to authenticate and authorize communications between a UE deployed on an UAV and the first network entity. In some cases, the operations of this step refer to, or may be performed by, circuitry for performing and/or code for performing as described with reference to FIG. 15.

Method 1300 then proceeds to step 1310 with providing security material, as part of the first procedure, to at least the first network entity for use in securing communications when the first network entity provides network-based aviation service to the UE. In some cases, the operations of this step refer to, or may be performed by, circuitry for providing and/or code for providing as described with reference to FIG. 15.

In some aspects, the second network entity comprises: an USS node; or a UTM node.

In some aspects, the security material comprises at least one of security keys, certificates, or access tokens.

In some aspects, the first procedure comprises an authentication and authorization procedure performed using an API to communicate with the second network entity via a NF; and the second network entity determines the first procedure is to authenticate and authorize communications between the UE and the first network entity, based on a server ID provided by the first network entity.

In some aspects, the second network entity provides, as part of the first procedure, a first authentication message for the first network entity and a second authentication message for the UE.

In some aspects, the method 1300 further includes providing an indication of whether communication between the first network entity and UE is authorized. In some cases, the operations of this step refer to, or may be performed by, circuitry for providing and/or code for providing as described with reference to FIG. 15.

In some aspects, the method 1300 further includes performing a second procedure with the UE, to authorize and authenticate the UAV. In some cases, the operations of this step refer to, or may be performed by, circuitry for performing and/or code for performing as described with reference to FIG. 15.

In some aspects, the method 1300 further includes transmitting a first indication to the first network entity to indicate a pending status during which the first network entity should refrain from communicating with the UE. In some cases, the operations of this step refer to, or may be performed by, circuitry for transmitting and/or code for transmitting as described with reference to FIG. 15.

In some aspects, the method 1300 further includes transmitting a second indication to the first network entity to indicate release of the pending status. In some cases, the operations of this step refer to, or may be performed by, circuitry for transmitting and/or code for transmitting as described with reference to FIG. 15.

In some aspects, the second network entity receives, from the first network entity, an ID of the UAV to request the second network entity to authorize communication between the first network entity and the UE.

In some aspects, the method 1300 further includes providing the security material to the first network entity and the UE if the second network entity authorizes communication between the first network entity and the UE. In some cases, the operations of this step refer to, or may be performed by, circuitry for providing and/or code for providing as described with reference to FIG. 15.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations of a User Equipment

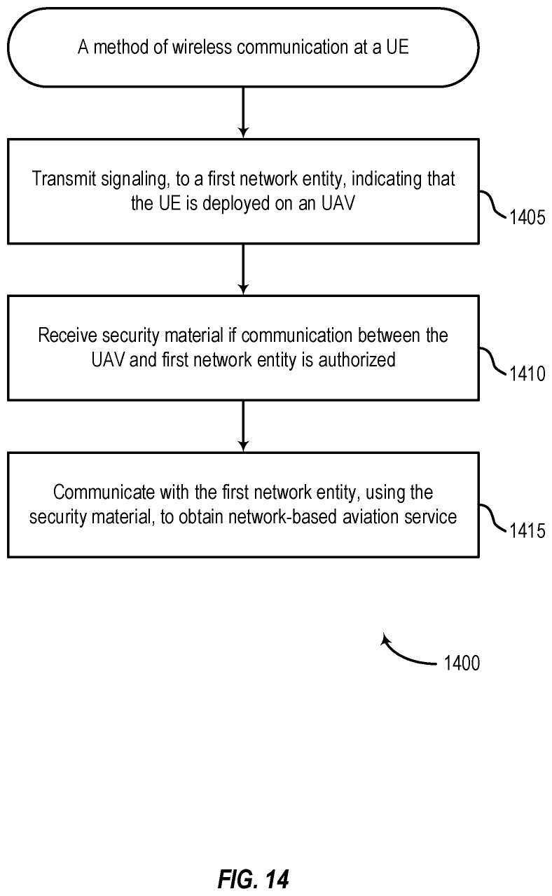

FIG. 14 shows an example of a method 1400 of wireless communication at a UE, such as a UE 104 of FIGS. 1 and 3.

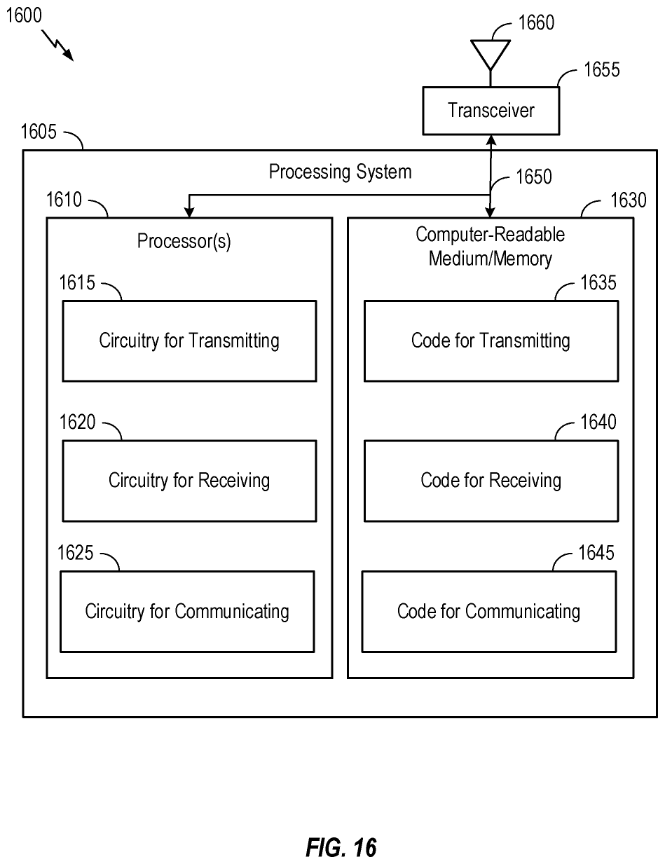

Method 1400 begins at step 1405 with transmitting signaling, to a first network entity, indicating that the UE is deployed on an UAV. In some cases, the operations of this step refer to, or may be performed by, circuitry for transmitting and/or code for transmitting as described with reference to FIG. 16.

Method 1400 then proceeds to step 1410 with receiving security material if communication between the UAV and first network entity is authorized. In some cases, the operations of this step refer to, or may be performed by, circuitry for receiving and/or code for receiving as described with reference to FIG. 16.

Method 1400 then proceeds to step 1415 with communicating with the first network entity, using the security material, to obtain network-based aviation service. In some cases, the operations of this step refer to, or may be performed by, circuitry for communicating and/or code for communicating as described with reference to FIG. 16.

In some aspects, the security material comprises at least one of security keys, certificates, or access tokens.

In some aspects, the security material is obtained as part of an authentication and authorization procedure performed with the first network entity.

In some aspects, the security material is obtained as part of an authentication and authorization procedure performed with a second network entity; or the security material is obtained if communication between the UAV and first network entity is authorized by the second network entity.

In some aspects, the second network entity comprises: an USS node; or a UTM node.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Device

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1582 (e.g., a transmitter and/or a receiver) and/or a network interface 1586. The transceiver 1582 is configured to transmit and receive signals for the communications device 1500 via the antenna 1584, such as the various signals as described herein. The network interface 1586 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1545 via a bus 1580. In certain aspects, the computer-readable medium/memory 1545 is configured to store instructions (e.g., computer-executable code) that when executed by the one or more processors 1510, cause the one or more processors 1510 to perform: the method 1200 described with respect to FIG. 12, or any aspect related to it; and/or the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1545 stores code (e.g., executable instructions), such as code for receiving 1550, code for performing 1555, code for communicating 1560, code for providing 1565, code for refraining 1570, and code for transmitting 1575. Processing of the code for receiving 1550, code for performing 1555, code for communicating 1560, code for providing 1565, code for refraining 1570, and code for transmitting 1575 may cause the communications device 1500 to perform: the method 1200 described with respect to FIG. 12, or any aspect related to it; and/or the method 1300 described with respect to FIG. 13, or any aspect related to it.

The one or more processors 1510 include circuitry configured to implement (e.g., execute) the code stored in the computer-readable medium/memory 1545, including circuitry such as circuitry for receiving 1515, circuitry for performing 1520, circuitry for communicating 1525, circuitry for providing 1530, circuitry for refraining 1535, and circuitry for transmitting 1540. Processing with circuitry for receiving 1515, circuitry for performing 1520, circuitry for communicating 1525, circuitry for providing 1530, circuitry for refraining 1535, and circuitry for transmitting 1540 may cause the communications device 1500 to perform: the method 1200 described with respect to FIG. 12, or any aspect related to it; and/or the method 1300 described with respect to FIG. 13, or any aspect related to it.

Various components of the communications device 1500 may provide means for performing: the method 1200 described with respect to FIG. 12, or any aspect related to it; and/or the method 1300 described with respect to FIG. 13, or any aspect related to it. Means for transmitting, sending or outputting for transmission may include transceivers 332 and/or antenna(s) 334 of the BS 102 illustrated in FIG. 3 and/or the transceiver 1582 and the antenna 1584 of the communications device 1500 in FIG. 15. Means for receiving or obtaining may include transceivers 332 and/or antenna(s) 334 of the BS 102 illustrated in FIG. 3 and/or the transceiver 1582 and the antenna 1584 of the communications device 1500 in FIG. 15.

FIG. 16 depicts aspects of an example communications device 1600. In some aspects, communications device 1600 is a user equipment, such as a UE 104 described above with respect to FIGS. 1 and 3.

The communications device 1600 includes a processing system 1605 coupled to the transceiver 1655 (e.g., a transmitter and/or a receiver). The transceiver 1655 is configured to transmit and receive signals for the communications device 1600 via the antenna 1660, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1630 via a bus 1650. In certain aspects, the computer-readable medium/memory 1630 is configured to store instructions (e.g., computer-executable code) that when executed by the one or more processors 1610, cause the one or more processors 1610 to perform the method 1400 described with respect to FIG. 14, or any aspect related to it. Note that reference to a processor performing a function of communications device 1600 may include one or more processors 1610 performing that function of communications device 1600.

In the depicted example, computer-readable medium/memory 1630 stores code (e.g., executable instructions), such as code for transmitting 1635, code for receiving 1640, and code for communicating 1645. Processing of the code for transmitting 1635, code for receiving 1640, and code for communicating 1645 may cause the communications device 1600 to perform the method 1400 described with respect to FIG. 14, or any aspect related to it.

The one or more processors 1610 include circuitry configured to implement (e.g., execute) the code stored in the computer-readable medium/memory 1630, including circuitry such as circuitry for transmitting 1615, circuitry for receiving 1620, and circuitry for communicating 1625. Processing with circuitry for transmitting 1615, circuitry for receiving 1620, and circuitry for communicating 1625 may cause the communications device 1600 to perform the method 1400 described with respect to FIG. 14, or any aspect related to it.

Various components of the communications device 1600 may provide means for performing the method 1400 described with respect to FIG. 14, or any aspect related to it. For example, means for transmitting, sending or outputting for transmission may include transceivers 354 and/or antenna(s) 352 of the UE 104 illustrated in FIG. 3 and/or the transceiver 1655 and the antenna 1660 of the communications device 1600 in FIG. 16. Means for receiving or obtaining may include transceivers 354 and/or antenna(s) 352 of the UE 104 illustrated in FIG. 3 and/or the transceiver 1655 and the antenna 1660 of the communications device 1600 in FIG. 16.

### Example Clauses

Implementation examples are described in the following numbered clauses:
Clause 1: A method of wireless communication at a first network entity, comprising: receiving signaling indicating that a UE is deployed on an UAV; performing a first procedure with a second network entity to authenticate and authorize communications between the UE and the first network entity; and communicating with the UE, using security material obtained via the first procedure, to provide network-based aviation service.
Clause 2: The method of Clause 1, wherein the second network entity comprises: an USS node; or a UTM node.
Clause 3: The method of any one of Clauses 1 and 2, wherein the security material comprises at least one of security keys, certificates, or access tokens.
Clause 4: The method of any one of Clauses 1-3, wherein: the first procedure comprises an authentication and authorization procedure performed using an API to communicate with the second network entity via a NF; and the first network entity provides the second network entity a server ID to indicate the first procedure is to authenticate and authorize communications between the UE and the first network entity.
Clause 5: The method of Clause 4, wherein: the first network entity obtains, as part of the first procedure, a first authentication message for the first network entity and a second authentication message for the UE; and the method further comprises performing a second procedure with the UE to provide the UE with the second authentication message.
Clause 6: The method of Clause 5, further comprising: providing the UE with results of the second procedure and the security material.
Clause 7: The method of Clause 4, wherein: the first network entity provides the second network entity an ID of the UAV to trigger the second network entity to perform a second procedure to authenticate and authorize the UE.
Clause 8: The method of Clause 7, further comprising: receiving, from the second network entity, a first indication indicating a pending status during which the first network entity should refrain from communicating with the UE; and refraining from communicating with the UE until after receiving, from the second network entity, a second indication indicating a release of the pending status.
Clause 9: The method of Clause 4, wherein: the first network entity provides the second network entity an ID of the UAV to request the second network entity to authorize communication between the first network entity and the UE.
Clause 10: The method of Clause 9, wherein: the second network entity provides the security material to the first network entity and UE.
Clause 11: A method of wireless communication at a second network entity, comprising: performing a first procedure with a first network entity to authenticate and authorize communications between a UE deployed on an UAV and the first network entity; and providing security material, as part of the first procedure, to at least the first network entity for use in securing communications when the first network entity provides network-based aviation service to the UE.
Clause 12: The method of Clause 11, wherein the second network entity comprises: an USS node; or a UTM node.
Clause 13: The method of any one of Clauses 11 and 12, wherein the security material comprises at least one of security keys, certificates, or access tokens.
Clause 14: The method of any one of Clauses 11-13, wherein: the first procedure comprises an authentication and authorization procedure performed using an API to communicate with the second network entity via a NF; and the second network entity determines the first procedure is to authenticate and authorize communications between the UE and the first network entity, based on a server ID provided by the first network entity.
Clause 15: The method of Clause 14, wherein: the second network entity provides, as part of the first procedure, a first authentication message for the first network entity and a second authentication message for the UE.
Clause 16: The method of Clause 15, further comprising: providing an indication of whether communication between the first network entity and UE is authorized.
Clause 17: The method of Clause 14, further comprising: performing a second procedure with the UE, to authorize and authenticate the UAV.
Clause 18: The method of Clause 17, further comprising: transmitting a first indication to the first network entity to indicate a pending status during which the first network entity should refrain from communicating with the UE; and transmitting a second indication to the first network entity to indicate release of the pending status.
Clause 19: The method of Clause 14, wherein: the second network entity receives, from the first network entity, an ID of the UAV to request the second network entity to authorize communication between the first network entity and the UE.
Clause 20: The method of Clause 19, further comprising: providing the security material to the first network entity and the UE if the second network entity authorizes communication between the first network entity and the UE.
Clause 21: A method of wireless communication at a UE, comprising: transmitting signaling, to a first network entity, indicating that the UE is deployed on an UAV; receiving security material if communication between the UAV and first network entity is authorized; and communicating with the first network entity, using the security material, to obtain network-based aviation service.
Clause 22: The method of Clause 21, wherein the security material comprises at least one of security keys, certificates, or access tokens.
Clause 23: The method of any one of Clauses 21 and 22, wherein: the security material is obtained as part of an authentication and authorization procedure performed with the first network entity.
Clause 24: The method of any one of Clauses 21-23, wherein: the security material is obtained as part of an authentication and authorization procedure performed with a second network entity; or the security material is obtained if communication between the UAV and first network entity is authorized by the second network entity.
Clause 25: The method of Clause 24, wherein the second network entity comprises: an USS node; or a UTM node.
Clause 26: An apparatus, comprising: a memory comprising executable instructions; and a processor configured to execute the executable instructions and cause the apparatus to perform a method in accordance with any one of Clauses 1-25.
Clause 27: An apparatus, comprising means for performing a method in accordance with any one of Clauses 1-25.
Clause 28: A non-transitory computer-readable medium comprising executable instructions that, when executed by a processor of an apparatus, cause the apparatus to perform a method in accordance with any one of Clauses 1-25.
Clause 29: A computer program product embodied on a computer-readable storage medium comprising code for performing a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S. C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication at a first network entity, comprising:
receiving signaling indicating that a user equipment (UE) is deployed on an unmanned aerial vehicle (UAV);
performing a first procedure with a second network entity to authenticate and authorize communications between the UE and the first network entity; and
communicating with the UE, using security material obtained via the first procedure, to provide network-based aviation service.

2. The method of claim 1, wherein the second network entity comprises:
an unmanned aircraft system (UAS) service suppliers (USS) node; or
a UAS Traffic Management (UTM) node.

3. The method of claim 1, wherein the security material comprises at least one of security keys, certificates, or access tokens.

4. The method of claim 1, wherein:
the first procedure comprises an authentication and authorization procedure performed using an application programing interface (API) to communicate with the second network entity via a network function (NF); and
the first network entity provides the second network entity a server ID to indicate the first procedure is to authenticate and authorize communications between the UE and the first network entity.

5. The method of claim 4, wherein:
the first network entity obtains, as part of the first procedure, a first authentication message for the first network entity and a second authentication message for the UE; and
the method further comprises performing a second procedure with the UE to provide the UE with the second authentication message.

6. The method of claim 5, further comprising providing the UE with results of the second procedure and the security material.

7. The method of claim 4, wherein:
the first network entity provides the second network entity an ID of the UAV to trigger the second network entity to perform a second procedure to authenticate and authorize the UE.

8. The method of claim 7, further comprising:
receiving, from the second network entity, a first indication indicating a pending status during which the first network entity should refrain from communicating with the UE; and
refraining from communicating with the UE until after receiving, from the second network entity, a second indication indicating a release of the pending status.

9. The method of claim 4, wherein:
the first network entity provides the second network entity an ID of the UAV to request the second network entity to authorize communication between the first network entity and the UE.

10. The method of claim 9, wherein:
the second network entity provides the security material to the first network entity and UE.

11. A method of wireless communication at a second network entity, comprising:
performing a first procedure with a first network entity to authenticate and authorize communications between a user equipment (UE) deployed on an unmanned aerial vehicle (UAV) and the first network entity; and
providing security material, as part of the first procedure, to at least the first network entity for use in securing communications when the first network entity provides network-based aviation service to the UE.

12-13. (canceled)

14. The method of claim 11, wherein:
the first procedure comprises an authentication and authorization procedure performed using an application programing interface (API) to communicate with the second network entity via a network function (NF); and
the second network entity determines the first procedure is to authenticate and authorize communications between the UE and the first network entity, based on a server ID provided by the first network entity.

15. The method of claim 14, wherein:
the second network entity provides, as part of the first procedure, a first authentication message for the first network entity and a second authentication message for the UE.

16. The method of claim 15, further comprising providing an indication of whether communication between the first network entity and UE is authorized.

17. The method of claim 14, further comprising performing a second procedure with the UE, to authorize and authenticate the UAV.

18. The method of claim 17, further comprising:
transmitting a first indication to the first network entity to indicate a pending status during which the first network entity should refrain from communicating with the UE; and
transmitting a second indication to the first network entity to indicate release of the pending status.

19. The method of claim 14, wherein:
the second network entity receives, from the first network entity, an ID of the UAV to request the second network entity to authorize communication between the first network entity and the UE.

20. The method of claim 19, further comprising:
providing the security material to the first network entity and the UE if the second network entity authorizes communication between the first network entity and the UE.

21. A method of wireless communication at a user equipment (UE), comprising:
transmitting signaling, to a first network entity, indicating that the UE is deployed on an unmanned aerial vehicle (UAV);
receiving security material if communication between the UAV and first network entity is authorized; and
communicating with the first network entity, using the security material, to obtain network-based aviation service.

22-23. (canceled)

24. The method of claim 21, wherein:
the security material is obtained as part of an authentication and authorization procedure performed with a second network entity; or
the security material is obtained if communication between the UAV and first network entity is authorized by the second network entity.

25. (canceled)
